(19) United States
(12) Patent Application Publication
(10) Pub. No.: US 2017/0268208 A1
(43) Pub. Date: Sep. 21, 2017

(54) APPARATUS AND METHOD FOR FAUCET CONTROL

(71) Applicant: 9329-5459 Quebec Inc., Pierrefonds (CA)

(72) Inventor: Francois LaMarche, Pierrefonds (CA)

(21) Appl. No.: 15/532,330

(22) PCT Filed: Dec. 4, 2015
(86) PCT No.: PCT/CA2015/051275

§ 371 Date: Jun. 1, 2017

Related U.S. Application Data
(60) Provisional application No. 62/087,842, filed on Dec. 5, 2014.

(51) Int. Cl. E03C 1/05; G05D 7/06; F16K 11/00; G05D 23/13

(52) U.S. Cl. CPC E03C 1/057; G05D 23/1393; G05D 7/0617; F16K 19/006

(57) ABSTRACT

A faucet system for providing adjustable water flow is provided. The system includes hot and cold water valves operable to respectively control a flow of hot and cold water, a sensor pad with substantially continuous sensing axes, and a controller in communication with the sensor pad and operatively connected to the hot and cold water valves. The controller processes user gestures detected using the sensor pad to determine a selected flow temperature or a selected flow magnitude from a substantially continuous range of possible values, and operate the hot and cold water valves to attain the selected flow temperature or the selected flow magnitude. A method is also provided for operating the same, along with a kit for retrofitting existing faucet assemblies in order to form a faucet system.

### FIELD

The present disclosure relates to the field of control of water faucets. More particularly, it relates to apparatuses and methods for controlling the temperature and flow of water from a faucet.

### BACKGROUND

Water faucets typically include valves which allow the control of temperature and fluid flow.

In many applications, it is desirable to have a convenient and intuitive means for a user to control the valve. For practical and sanitary purposes, it is also often desirable to have a valve which can be controlled without the use of the user's hands.

Several systems taking these issues under consideration are known in the art:

U.S. Pat. No. 7,766,026 teaches the use of a touch panel for fluid flow control. The touch panel is provided next to the faucet and is divided into separate areas, each one being associated with a given discrete setting of flow and temperature of water flowing from the faucet. However, the disclosed system does not give a user continuous control over water flow and temperature.

U.S. Pat. No. 8,132,778 teaches the use of a touch-sensitive remote control which is either an electric or electronic switch. This switch provides a single signal which commands a valve to toggle on and off, without enabling the adjustment of the magnitude of the water flow, nor its temperature.

U.S. Pat. Nos. 8,827,239 and 8,418,893 describe an apparatus providing continuous water flow and temperature control by means of at least three electronic proximity sensors, a first valve specifically controlling water flow and a second valve controlling the hot and cold water mix. However, this may not be very intuitive to operate by a human user.

U.S. Pat. No. 8,844,564 teaches an apparatus providing a Human Interface Device (HID) using a proximity sensor and touch sensors on the faucet spout and handle in order to control water flow. This apparatus uses two different types of sensors and may not be very intuitive to use.

U.S. Pat. No. 8,365,767 teaches an apparatus using two distinct touch sensors, a first sensor for controlling the water temperature through the use of a mixing valve and a second distinct sensor for controlling water flow. The user therefore has to interface with two different sensors to obtain the desired temperature/water flow setting which may not be very practical.

U.S. Pat. No. 8,649,054 also teaches an apparatus allowing to control the water temperature through the use of a mixing valve and to control the water flow through the use of a second valve. It uses touch sensors to control discrete settings of water temperature delivery and therefore does not allow continuous water flow and temperature control.

Finally, US Patent Application No. 2010/0065764 teaches the control of the ratio of mixing hot and cold water of an electronic faucet by setting a mixing valve with an electronics actuator using two infrared sensors without touching to the faucet or its accessories. The system consists of two infrared sensors and does not allow control of water flow.

There remains a need for an improved valve control apparatus which solves at least some of the above-mentioned deficiencies of the prior art.

### SUMMARY

According to an aspect, a method for adjusting water flow through a faucet system is provided. The method includes the steps of: generating a gesture signal responsive to a user gesture along one or two substantially continuous axes of a sensor pad; and with respect to each of said one or two substantially continuous axes: processing the gesture signal to determine therefrom a selected flow temperature or a selected flow magnitude from a substantially continuous range of possible values; and automatically adjusting at least one of a hot component and a cold component of a flow of water through the faucet system such that a combined flow of said hot and cold components corresponds to the selected flow temperature or the selected flow magnitude.

In an embodiment, automatically adjusting the at least one of the hot component and the cold component includes modifying a ratio of the hot component to the cold component.

In an embodiment, automatically adjusting the at least one of the hot component and the cold component includes modifying a combined flow magnitude of the hot component and the cold component.

In an embodiment, the one or two substantially continuous axes include first and second orthogonal axes, and processing the gesture signal includes determining the selected flow temperature according to a component of the user gesture along the first axis, and determining the selected flow magnitude according to a component of the user gesture along the second axis.

In an embodiment, processing the gesture signal includes determining a relative distance traveled by the user gesture along the corresponding substantially continuous axis, and mapping the relative distance traveled to a relative change in the selected flow temperature or the selected flow magnitude.

In an embodiment, the gesture signal includes coordinates corresponding to positions of the user gesture along the one or two substantially continuous axes, and processing the gesture signal includes mapping the coordinates to the selected flow temperature or the selected flow magnitude.

In an embodiment, mapping the coordinates includes: identifying a starting coordinate corresponding to a start position of the user gesture along the corresponding substantially continuous axis; identifying an ending coordinate corresponding to an end position of the user gesture along the corresponding substantially continuous axis; calculating a difference between the starting and ending coordinates; and mapping the difference to a change in the selected flow temperature or the selected flow magnitude.

In an embodiment, adjusting the at least one of the hot component and the cold component includes operating at least one of a hot water valve and a cold water valve, the hot and cold water valves respectively controlling water flow from a hot water source and a cold water source.

In an embodiment, the hot and cold water valves are operated by actuators, and automatically adjusting the at least one of the hot component and the cold component includes generating actuator control signals to automatically operate the actuators.

In an embodiment, automatically adjusting the at least one of the hot component and the cold component includes determining opening set-points for each of the hot and cold water valves, and operating the hot and cold water valves to their respective determined opening set-points.

In an embodiment, the opening set-points include open-loop coarse opening set-points and closed-loop fine opening set-points, and automatically adjusting the at least one of the hot component and the cold component includes: determining the coarse opening set-points; respectively operating the hot and cold water valves to their determined coarse opening set-points; receiving an output feedback signal corresponding to a measured temperature of the combined flow of the hot and cold components; determining an error between the selected flow temperature and the output feedback signal; and reducing the error by respectively modifying the hot and cold water valves to the fine opening set-points while maintaining the output flow constant.

In an embodiment, determining the coarse opening set-points includes the steps of: receiving two input signals corresponding to measured temperatures of the hot and cold components, respectively; determining a ratio of the hot component to the cold component required to obtain the selected flow temperature, according to the hot and cold component input signals; determining a scaling factor of the hot component and the cold component required to obtain the selected flow magnitude; and calculating the coarse opening set-points of the hot and cold valves respectively, scaled to obtain the selected flow magnitude while respecting the determined ratio of the hot component to the cold component.

In an embodiment, the input signals are measured over the course of a predetermined period of time in order to estimate temperatures of the hot and cold input components, respectively.

In an embodiment, the method further includes the step of mixing the hot and cold components before providing them to an input of an existing faucet assembly.

In an embodiment, the existing faucet assembly includes a hot water input and a cold water input, and the method includes the step of providing the mixed hot and cold components to one of the hot water input and the cold water input of the existing faucet assembly.

In an embodiment, the one of the hot water input of the existing faucet assembly is set to a near maximum magnitude, and the other one of the hot water input and the cold water input of the existing faucet assembly is set to a near zero magnitude.

In an embodiment, the method further includes receiving a command to enter a non-instrumented mode and, responsive to said command, automatically adjusting the flow of water through the faucet system, the flow of water through the faucet system including the hot component at a near maximum magnitude and the cold component at a near zero magnitude.

In an embodiment, processing the gesture signal includes identifying whether the user gesture corresponds to one of a stroke gesture and a tap gesture.

In an embodiment, upon identifying a stroke gesture, the faucet system is operable to continuously adjust the selected flow temperature or the selected flow magnitude according to the stroke gesture.

In an embodiment, the faucet system is operable between an open state in which water flows through the faucet system, and a closed state in which water flow through the faucet system is interrupted, and upon identifying the tap gesture, the selected flow temperature or the selected flow magnitude is adjusted instantaneously according to a commanded open-to-close or close-to open state transition.

In an embodiment, upon identifying the tap gesture while the faucet system is in the open state, the faucet system is automatically operated into the closed state, and upon identifying the tap gesture while the faucet system is in the closed state, the faucet system is automatically operated to enter the open state.

In an embodiment, the method further includes the steps of storing a current flow temperature and flow magnitude in memory before operating the faucet system into the closed state, and restoring the stored flow temperature and flow magnitude from memory when operating the faucet system into the open state.

In an embodiment, identifying a tap gesture includes identifying a number of sequential taps “n” and, upon identifying n sequential taps while the faucet system is in the open position, a current flow temperature and flow magnitude are associated with the n sequential taps in memory and, upon identifying n sequential taps while the faucet system is in the closed position, the flow temperature and flow magnitude associated with the n sequential taps are restored.

In an embodiment, the method further includes the step of limiting the selected flow temperature and the selected flow magnitude to a predetermined range.

In an embodiment, the sensor pad includes a foot-operated sensor pad.

In an embodiment, the sensor pad includes a touchpad.

In an embodiment, the touchpad is a resistive touchpad.

According to an aspect, a kit for retrofitting a faucet assembly and forming a faucet system is provided. The kit includes: a hot water valve connectable to a hot water source and operable to control a flow of hot water into the faucet assembly; a cold water valve connectable to a cold water source and operable to control a flow of cold water into the faucet assembly; a sensor pad having one or two substantially continuous sensing axes, the sensor pad generating a gesture signal responsive to a user gesture along the one or two substantially continuous sensing axes; and a controller in communication with the sensor pad and operatively connectable to the hot and cold water valves, the controller being operable to process the gesture signal along each of the one or two substantially continuous sensing axis to: determine a selected flow temperature or a selected flow magnitude from a substantially continuous range of possible values; and operate the hot and cold water valves to automatically control the flow of hot water and cold water such that a combined flow of the hot and cold water through the faucet assembly corresponds to the selected flow temperature or the selected flow magnitude.

In an embodiment, the one or two substantially continuous axes include first and second orthogonal axes, and processing the gesture signal includes determining the selected flow temperature according to a component of the user gesture along the first axis, and determining the selected flow magnitude according to a component of the user gesture along the second axis.

In an embodiment, the kit further includes hot and cold valve actuators, the controller being operable to generate actuator control signals to automatically control the flow of hot and cold water, respectively, into the faucet assembly.

In an embodiment, the hot and cold valve actuators are operable between substantially continuous ranges of opening set-points.

In an embodiment, the input temperature sensors configured to communicate with the controller, the input temperature sensors being operable to respectively measure temperatures of the hot and cold water sources, and wherein the controller is operable to select an opening set-point of the hot and cold valve actuators based on the measured temperatures, and to generate the corresponding actuator control signals.

In an embodiment, the controller further includes an input memory module, the input memory module storing previous temperatures measured by the input temperature sensors, and wherein the controller is operable to select the opening set-point of the hot and cold valve actuators based on the previous temperatures.

In an embodiment, the kit further includes an output temperature sensor configured to communicate with the controller, the output temperature sensor being operable to measure a temperature of the combined hot and cold water flow through the faucet assembly.

In an embodiment, the controller further includes an output memory module storing a previous flow temperature and a previous flow magnitude, and wherein the controller is operable to determine the selected flow temperature or the selected flow magnitude by reading the previous flow temperature or the previous flow magnitude stored in the output memory module.

In an embodiment, the sensor pad includes a foot-operable sensor pad.

In an embodiment, the sensor pad includes a touchpad.

In an embodiment, the touchpad is a resistive touchpad.

According to an aspect, a faucet system is provided for providing an adjustable water flow. The system includes: a hot water inlet; a cold water inlet; a mixed water outlet; hot and cold water valves operable to respectively control a flow of hot water through the hot water inlet and a flow of cold water through the cold water inlet, the flows of hot and cold water combining into a flow of mixed water through the mixed water outlet; a sensor pad having one or two substantially continuous sensing axes, the sensor pad generating a gesture signal responsive to a user gesture along the one or two substantially continuous sensing axes; and a controller in communication with the sensor pad and operatively connected to the hot and cold water valves, the controller being operable to process the gesture signal along each of the one or two substantially continuous sensing axes to: determine a selected flow temperature or a selected flow magnitude from a substantially continuous range of possible values; and operate the hot and cold water valves to automatically control the flow of hot water and cold water such that the flow of the mixed water corresponds to the selected flow temperature or the selected flow magnitude.

In an embodiment, the one or two substantially continuous axes include first and second orthogonal axes, and wherein processing the gesture signal includes determining the selected flow temperature according to a component of the user gesture along the first axis, and determining the selected flow magnitude according to a component of the user gesture along the second axis.

In an embodiment, the system further includes hot and cold valve actuators respectively operable by actuator control signals to automatically control the hot and cold water valves.

In an embodiment, the hot and cold valve actuators are operable between substantially continuous ranges of opening set-points.

In an embodiment, the system further includes input temperature sensors in communication with the controller, the input temperature sensors respectively measuring temperatures of the hot and cold water inlets, and wherein the controller is operable to select an opening set-point of the hot and cold valve actuators based on the measured temperatures, and to generate the corresponding actuator control signals.

In an embodiment, the controller further includes an input memory module, the input memory module storing previous temperatures measured by the input temperature sensors, and wherein the controller is operable to select the opening set-point of the hot and cold valve actuators based on the previous temperatures.

In an embodiment, the system further includes an output temperature sensor in communication with the controller, the output temperature sensor measuring a temperature of the mixed water.

In an embodiment, the controller further includes an output memory module storing a previous flow temperature and a previous flow magnitude, and wherein the controller is operable to determine the selected flow temperature or the selected flow magnitude by reading the previous flow temperature or the previous flow magnitude stored in the output memory module.

In an embodiment, the sensor pad includes a foot-operated sensor pad.

In an embodiment, the sensor pad includes a touchpad.

In an embodiment, the touchpad is a resistive touchpad.

### BRIEF DESCRIPTION OF THE DRAWINGS

FIG. 1 is a schematic of a faucet system for adjustably controlling water flow, according to an embodiment

FIGS. 2 and 3 are schematics illustrating signal processing techniques according to an embodiment, for converting a gesture signal into flow magnitude and flow temperature set points, and converting those set points into opening set points of hot and cold water valves.

FIG. 4 is a block diagram illustrating a temperature control closed-loop system, according to an embodiment.

FIG. 5 is a schematic depicting piping and valve arrangement for the purpose of retrofitting existing faucet assemblies and forming a faucet system, according to an embodiment.

FIG. 6 is a schematic depicting piping and valve arrangement for the purpose of retrofitting existing faucet installations, according to an alternate embodiment.

### DETAILED DESCRIPTION

Embodiments of the present invention generally provide apparatuses and methods for controlling water flow from a faucet assembly using a sensor pad. In some embodiments, the sensor pad is foot operated. In some embodiments, the sensor pad includes a first axis allowing the control of the magnitude of water flowing from the faucet, and a second axis orthogonal to the first axis, allowing the control of the temperature of water flowing from the faucet. In some embodiments, the sensor pad includes first and second orthogonal substantially continuous sensing axes for allowing the substantially continuous control of the magnitude and/or temperature of water flowing from the faucet.

### 1. System for Providing Adjustable Water Flow

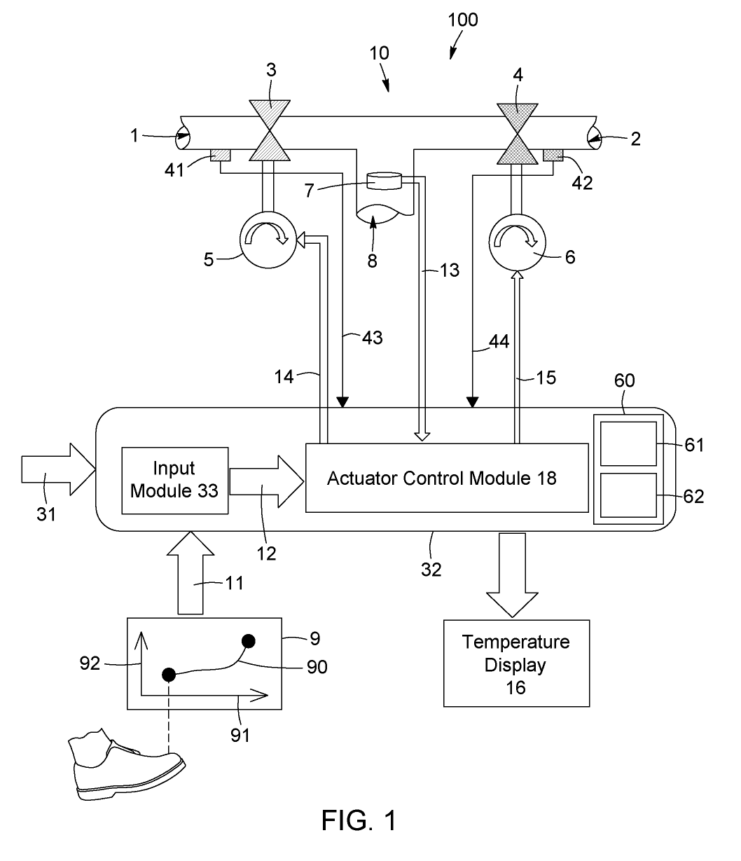

With reference to FIG. 1, a faucet system 100 for providing an adjustable water flow is shown according to one implementation. The faucet system 100 includes a faucet assembly 10 through which the flow of water will be adjusted. The faucet assembly 10 can be any type of fixture or collection of tubing which allows for the controlled release of fluid, and which can allow for the mixing and controlled flow of fluid from one or a plurality of inputs. In the some embodiments, the faucet assembly 10 may for example be a kitchen sink tap fixture which releases mixed water from hot and cold sources. However, in alternate embodiments, other types of faucet assemblies are also possible, such as a bath fixture, a shower fixture, a bathroom sink fixture, or the like. The faucet system 100 according to this embodiment may for example be installed instead of a regular faucet assembly at the initial installation of the corresponding fixture or during major renovations, for example.

In the illustrated embodiment, the faucet system 100 includes a cold water inlet 1, a hot water inlet 2, and a faucet outlet 8 (also referred to as a mixed water outlet). Although in the present embodiment the faucet system 100 includes two inlets 1 and 2, it should be appreciated that in other embodiments, more or fewer inlets are also possible. It should be further appreciated that in alternate embodiments, the faucet system 100 can comprise several outlets.

Flow of water through the faucet system 100 is typically controlled by valves. In the embodiment of FIG. 1, the faucet system 100 includes cold and hot water valves 3 and 4 operable to respectively control a flow of cold water through the cold water inlet 1 and a flow of hot water through the hot water inlet 2. The flows of cold and hot water combine into a flow mixed water through the mixed water outlet 8. The cold and hot water valves 3, 4 can be any type of mechanism which allows for the continuous control of fluid flowing therethrough. Preferably, the cold and hot water valves are operable between a closed state in which no fluid flows, and a continuous range of open states in which water flows therethrough in a controlled fashion. Although in the present embodiment flow from the cold water inlet 1 is controlled by the cold water valve 3 and flow from the hot water inlet 2 is controlled by a hot water valve 4, it should be appreciated that in other embodiments, other valve configurations are also possible. For example, the cold and hot water inlets 1, 2 can both be controlled by a single mixing valve (not shown). Similarly, water flowing through the faucet outlet 8 can be controlled by an outlet valve (not shown).

In one embodiment, the faucet system 100 further includes cold and hot valve actuators 5 and 6 respectively operable by actuator control signals 14 and 15 to automatically control the hot and cold water valves 3, 4. Each of the actuator 5, 6 can be any mechanism which can be controlled in order to operate the corresponding cold or hot water valve 3, 4 between its closed and open states, preferably between a continuous range of opening-set points. In the present embodiment, the actuators 5, 6 include electric motors which are operable by electric signals embodying the actuator control signals 14, 15. In other embodiments, other types of actuators can also be used. For example, in alternate embodiments, the actuators can be driven by fluid or pneumatic pressure.

The actuator control signals 14, 15 can be any type of signal which can cause the actuators 5 and 6 to operate the cold and hot water valves 3, 4 between their closed and open states. In one implementation, as described further below, the actuator control signals 14, 15 may be embodied by digital signals which provide commands to the actuators 5, 6 to operate to a particular state. However, in alternate embodiments, other types of signals or different commands are possible. For example, the actuator control signals 14, 15 can instruct the actuators 5, 6 to operate between on/off states for a predetermined period of time, or to actuate at different speeds. In some embodiments, the actuator control signals 14, 15 can include an analog component, and can operate a motor mechanism in the actuators 5, 6 directly, for example.

It will be readily understood that in the illustrated embodiment, each of the cold and hot water valves 3, 4 is operated by a separate actuator control signals 14, 15. In this configuration, the actuators 5 and 6 allow controlling the individual flow of cold and hot water into the faucet system 100, and therefore the magnitude and temperature of water flowing out through the mixed water outlet 8. It should be appreciated, however, that the separate actuator control signals 14, 15 can be provided through a single channel. For example, they can be multiplexed and/or coded, allowing for the actuators 5, 6 to be controlled independently through a single electrical signal.

The faucet system 100 further includes a sensor pad 9 having one or two substantially continuous sensing axes 91 and 92. The sensor pad 9 generates a gesture signal 11 responsive to a user gesture 90 along the one or two substantially continuous sensing axes 91, 92, as further explained below.

The sensor pad 9 can be any device which can generate a signal responsive to user gestures. In one implementation, the sensor pad 9 is embodied by a touchpad, that is, an electrical sensor pad using a touch-sensitive technology. In one embodiment, the touchpad is a resistive touchpad. In such a variant, the touch-sensitive characteristics of the touchpad allow it to respond to movements of electrically insulating as well as electrically conductive materials on its surface. As can be appreciated, such a touchpad can therefore respond to bare skin, as well as garments such as gloves, socks and shoes of various types. Suitable resistive touchpads that are rugged and cost effective are readily available. It should be appreciated, however, that in alternate embodiments, other types of touchpads are also possible, such as a capacitive touchpad. It should also be appreciated that other types of sensor pads can also be provided in alternate embodiments, such as different types of tactile sensors, such as a pressure sensor, or non-tactile sensors, such as a proximity sensor.

In one implementation the sensor pad 9 is a foot-operated sensor pad, that is, it is configured and positioned such that a user can perform the user gesture using one of his or her feet. The sensor pad 9 can, for example, be mounted near the floor or another location, hidden or visible, which is easily accessible to a foot. The sensor pad 9 can further be sized and shaped to be more easily operated by a foot. For example, the sensor pad 9 can be wedge shaped, and have a surface which progressively protrudes outward towards a user between opposite edges. Advantageously, such a variant does not require the user's hands in order to operate the faucet system 100, freeing both hands for other functions and avoiding the potential transfer of germs on the user's hands to the faucet control implements. It should be appreciated, however, that in alternate embodiments, the sensor pad 9 can be configured for operation by other portions of the user's body, such as by a limb or facial gesture.

As mentioned above, the sensor pad 9 generates a gesture signal 11 responsive to user gestures 90 along first and second substantially continuous orthogonal axes 91, 92.

The sensor pad 9 can be used to receive commands from the user to independently control either or both the flow temperature and the flow magnitude of water outputted through the mixed water outlet 8. In some embodiments, therefore, the gesture signal 90 may reflect a user gesture along only one continuously sensing axis, and this gesture signal may be used to control only one parameter, either the flow temperature or the flow magnitude. In another variant, such as described herein, the two substantially continuous axes may include first and second orthogonal axes 91 and 92, and the gesture signal is processed to control both the flow temperature and the flow magnitude. Of course, such a control can be performed within the physical limits of flow and temperature ranges provided by the cold and hot water inlets 1, 2, as will be apparent from the description below.

As will be readily understood by one skilled in the art, the expression “substantially continuous” as applied to orthogonal axes 91, 92 refers to a succession of discrete points sufficiently close to one another so as to provide a near continuous effect, as perceived or perceivable by the user. For example, a touchpad having a touch sensitivity of 5 dots-per-inch (DPI) or more would provide such a substantially continuous character.

In one embodiment, the gesture signal 11 may include a stream of (x,y) coordinates of the impinging movement at regular time intervals and also provide a “Pen Up/Pen Down” status bit. It should be appreciated, however, that in alternate embodiments, other types of gesture signal configurations are also possible. For example, the gesture signal can provide (x,y) coordinate only at start and end points of a user gesture.

In the illustrated embodiment of FIG. 1, the first orthogonal axis 92 is the Y axis and the second orthogonal axis 91 is the X axis. Horizontal movement (along the X axis) is associated to water flow temperature (referred to hereafter as “water temperature”) and the vertical movement (along the Y axis) is associated to water flow magnitude (referred to hereafter as “water magnitude”).

Preferably, the sensor pad 9 can recognize swipe commands. In the present embodiment, a left-to-right horizontal movement or swipe is associated to a temperature decrease command, whereas a right-to-left movement is associated to a temperature increase command. Similarly, a vertical upwards movement is associated to a magnitude increase command and a downwards movement is associated to a magnitude decrease. Arbitrary movements comprising both horizontal and vertical components may be considered as composite temperature/magnitude commands. As can be appreciated, in such a configuration, the gesture signal can be processed to automatically adjust flow through the faucet system 100 according to a flow temperature and/or a flow magnitude selected by a user through the user's gesture.

“Pen Up/Pen Down” status bit, if available from the touchpad data can be used to determine the beginning and the end of strokes. If not available, the status may be derived by the monitoring of (x,y) coordinates over time. The first coordinate received after a certain time delay during which no data is received corresponds to a “Pen Down” status. The last coordinate received which precedes a certain time delay where no data is received corresponds to a “Pen Up” status.

The sensor pad 9 can preferably also receive tap command patterns. These consist of consecutive taps on the touchpad 9. In one implementation, the tap commands may for example be defined as follows:

TABLE 1
Tap Commands

| | When initial state is | When initial state is |
|---|---|---|
| TAP | “faucet open” | “faucet closed” |
| Single | Faucet Close Command | Faucet Open to the last |
| | | previous setting |
| Double | Defines set points equal to | Restores the set points |
| | present set points and | memorized by last double tap |
| | memorize these for future use | on “faucet Open” initial state |
| Triple | Defines set points equal to | Restores the set points |
| | present set points and | memorized by last triple tap on |
| | memorize these for future use | “faucet Open” initial state |
| Nth, | Defines set points equal to | Restores the set points |
| where | present set points and | memorized by last Nth tap on |
| N = 4, | memorize these for future use | “faucet Open” initial state |
| 5, 6 | | |

Still referring to FIG. 1, the faucet system 100 further includes a controller 32 in communication with the sensor pad 9 and operatively connected to the cold and hot water valves 3, 4. The controller 32 can be any type of device which is operable to process the gesture signal 11, as received from the sensor pad 9, to determine a selected flow temperature and/or selected flow magnitude associated with the user gesture, from a substantially continuous range of possible values. The controller 32 can also operate the cold and hot water valves 3, 4 to automatically control the flow of hot water and cold water, such that the flow of the mixed water corresponds to the selected flow temperature and/or the selected flow magnitude. In one implementation, the controller 32 may be embodied by an electronic controller. The electronic controller 32 can be a printed circuit board, for example, and can comprise logic processing elements, such as a microprocessor or an application specific integrated circuit (ASIC).

In one embodiment, the controller 32 generates the actuator control signals 14, 15 which control the actuators 5, 6 and thus control the magnitude and/or temperature of water flowing from the faucet outlet 8. This can be achieved by controlling a ratio and/or a combined magnitude of cold and hot water flowing from the cold and hot water inlets 1, 2. Various schemes may be used to calculate, predict or otherwise determine this ratio and combined magnitude, as will be readily understood by one skilled in the art. One implementation of a non-limitative method allowing such a control is explained further below.

Still referring to FIG. 1, the faucet system 100 may include input temperature sensors in communication with the controller 32. The input temperature sensors may include a cold input temperature sensor 41 and a hot input temperature sensor 42, respectively measuring temperatures of the cold and hot water inlets 1, 2. The controller 32 is operable to select an opening set-point of the cold and hot valve actuators 5, 6 based on the measured temperatures, and to generate the corresponding actuator control signals 14, 15. The input temperature sensors 41, 42 thereby generate feedback signals 43, 44 which can be used by the controller 32 to predict more precisely and control the temperature of water flowing through the faucet system 100. While such input temperature sensors can allow for more precise and accurate temperature predication and control, it should be appreciated that in alternate embodiments, they can be omitted without departing from the scope of the invention. Alternatively, in some embodiments, other types of sensors can also be provided to for more accurate control. For example, flow sensors can be provided to measure a specific flow rate or pressure in the cold and hot water inlets 1, 2.

As can be appreciated, water flowing from the cold and hot water inlets 1, 2 is mixed together and eventually exits through the mixed water outlet 8. Optionally, the faucet system 100 may further include an output temperature sensor 7, in communication with the controller 32 and measuring a temperature of the outputted mixed water flowing from the mixed water outlet 8. The output temperature sensor 7 may generate an output feedback signal 13 provided to the controller 32. The output feedback signal 13 can, for example be an electrical signal which includes temperature data. The output feedback signal 13 can be used by the controller 32 to more precisely control the temperature of water flowing through the faucet system 100, by providing a feedback signal for closed-loop control. While such a sensor can allow for more precise and accurate temperature control, it should be appreciated that in alternate embodiments, it may also be omitted without departing from the scope of the invention.

In some embodiments, the controller 32 can further be in communication with other user input/output devices to provide more functionality, a better user experience and/or to improve safety. For example, as shown in FIG. 1 an auxiliary button 31 may be provided in communication with the controller 32. The auxiliary button 31 can, for example, be used to operate the faucet system 100 between distinct modes, and can be concealed in some embodiments. It can further be used to input auxiliary commands to the controller 32, for example to set a maximum and/or minimum temperature or flow magnitude of the water flowing from the system.

The various signals received and transmitted by the controller 32 can be managed according to different hardware architectures. In the illustrated embodiment of FIG. 1, the electronic controller 32 includes an actuator control module 18 and an input module 33. The input module 33 receives input from human interface devices (HID) such as the sensor pad 9 and optionally a button 31, and transforms the input into set point data 12 useable by the actuator control module 18. In this configuration, the sensor pad 9 and the button 31 are in communication with the electronic controller 32. The input software module 33 is operatively connected to the actuator control software module 18 for communicating the data 12 thereto. It should be appreciated, however, that other configurations of the controller 32 are also possible.

As can be appreciated, the controller 32 can be provided with memory 60. In some embodiments, the memory 60 can be used to implement the functionality of the tap commands as described in Table 1 above. For example, the temperature and flow magnitude set-points can be stored in memory 60 responsive to a tap or a tap pattern. The stored temperature and magnitude set points can later be loaded from memory 60 responsive to a subsequent tap pattern in order to restore the flow magnitude and temperature. Such a configuration allows a state of the faucet to be saved and restored at a later time.

As can be further appreciated, the memory 60 in the controller 32 can further be used in order to improve the control of the cold and hot water valves 3, 4. The controller may for example include an input memory module 61 storing previous temperatures measured by the input temperature sensors 41, 42. The controller can then select the opening set-point of the hot and cold valve actuators based on an estimate of the cold and hot water inlet temperatures derived from previous temperature measurements at the cold and cold water inlets 1, 2 over a predetermined period of time. The previous temperature measurements can allow the controller 32 to better predict opening set points of the cold and hot water valves 3, 4 in order to attain an initial desired flow temperature and flow magnitude, without relying on instantaneous values of the input temperature sensors 41, 42.

In one implementation, the actuator control module 18 is also operatively connected to the output and input temperature sensors 7, 41 and 42 for receiving the temperature data 13, 43 and 44. Upon receiving and interpreting the set point data 12 and the temperature data 13, the actuator control software 18 generates the commands 14 and 15 for controlling the hot and cold water flow magnitude and temperature. The electronic controller 32 may also be operatively connected to a temperature display 16 for displaying the temperature data 13, or other data generated by the controller 32.

### 2. Kit for Retrofitting a Faucet Assembly

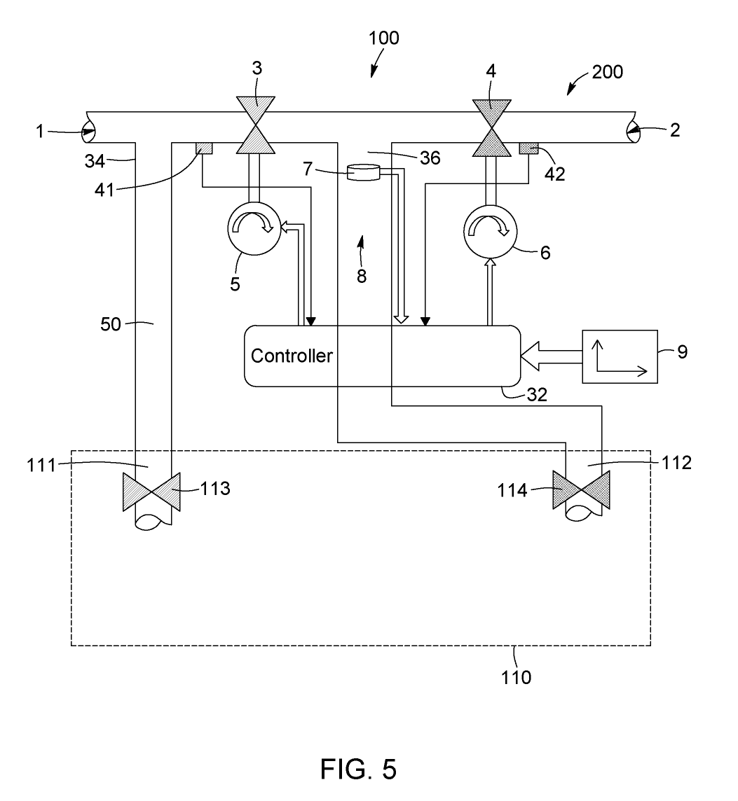

With reference to FIG. 5, according to another aspect, a kit 200 for retrofitting a faucet assembly 110 and forming a faucet system 100 is provided.

As will be readily understood by one skilled in the art, such a kit 200 may in some implementations be used by a home owner, plumber, contractor or other installer to provide flow temperature and/or magnitude control through a sensor pad such as described above, by adapting a pre-existing faucet assembly 110. As seen in FIG. 5, the components of the kit 200 may be associated to a faucet assembly 110 having a cold water inlet 111 with a cold water valve 113 and a hot water inlet 112 with a hot water valve 114. The kit 200, when installed and assembled, forms a faucet system 100 which allows water from hot and cold sources to be controlled before being provided to the faucet assembly 110. Preferably, the flows of hot and cold water are mixed before being provided to the faucet assembly 110, but in some embodiments they can be mixed while inside the faucet assembly 110. In this configuration, the flow temperature and/or magnitude of water ultimately flowing through the faucet assembly 110 can be controlled through user gestures.

As seen in FIG. 5, the kit 200 includes a hot water valve connectable 4 to a hot water source (not shown), through a hot water inlet 2. The hot water valve 4 is operable to control the flow of hot water into the faucet assembly 110. The kit 200 further includes a cold water valve 3 connectable to a cold water source (not shown) through a cold water inlet 1 and operable to control a flow of cold water into the faucet assembly 110. In some embodiments, the kit 200 may further include cold and hot valve actuators 5, 6, such as explained above.

The kit further includes a sensor pad 9 having one or two substantially continuous sensing axes as explained above. The sensor pad 9 generates a gesture signal responsive to a user gesture along one or both of the substantially continuous sensing axes. The sensor pad 9 may be embodied by a variety of devices, such as explained above. In some implementations, the sensor pad may be foot-operated, and may be embodied by a touchpad, for example a resistive touchpad.

In some implementations, the kit is configured to process the gesture signal to interpret the user gesture according to only one continuous sensing axis, to control either the flow temperature or the flow magnitude. In another variant, the one or two substantially continuous axes are defined by first and second orthogonal axes, the processing of the gesture determining the selected flow temperature according to a component of the user gesture along the first axis, and determining the selected flow magnitude according to a component of the user gesture along the second axis.

The kit 200 further includes a controller 32 in communication with the sensor pad 9, and operatively connectable to the cold and hot water valves 3, 4. The controller 9 is operable to process the gesture signal along the one or two substantially continuous sensing axes. Through this processing, the controller 32 can determine a selected flow temperature or a selected flow magnitude from a substantially continuous range of possible values, and operate the hot and cold water valves 4, 3 to automatically control the flow of hot water and cold water such that a combined flow of the hot and cold water through the faucet assembly 110 corresponds to the selected flow temperature or the selected flow magnitude. This is for example achieved through the generating of actuator control signals 14, 15, such as explained above. In some implementations, the cold and hot valve actuators 5, 6 may be operable between substantially continuous ranges of opening set-points.

Still in the illustrated embodiment, the kit 200 may further include input temperature sensors 41, 42 configured to communicate with the controller 32. The input temperature sensors 41, 42 are operable to respectively measure temperatures of the hot and cold water sources, through the cold water inlet 1 and the hot water inlet 2. The controller 32 can for example select an opening set-point of the cold and hot valve actuators 5, 6 based on the measured temperatures, and generate the corresponding actuator control signals 14, 15. In some embodiments, the controller 32 further comprises an input memory module 61, storing previous temperatures measured by the input temperature sensors. The controller 32 may in this case be operable to select the opening set-point of the cold and hot valve actuators 5, 6 based on the previous temperatures.

Additionally, the kit 200 may further include an output temperature sensor 7 configured to communicate with the controller 32. The output temperature sensor 7 may be operable to measure a temperature of the combined hot and cold water flow through the faucet assembly 110. The controller 32 may be further provided with an output memory module 62 storing a previous flow temperature and a previous flow magnitude, the controller thereby determining the selected flow temperature or the selected flow magnitude by reading the previous flow temperature or the previous flow magnitude stored in the output memory module 62.

The kit can also optionally include the temperature display 16 and any other suitable additional component.

In the arrangement depicted in FIG. 5, the mixed water outlet 8 is connected to the hot water inlet pipe 112 of the faucet assembly 110 being retrofitted. The cold water inlet 1 is connected to a second outlet pipe 50 with a T-section 34. In this configuration, a bypass path is provided for the cold water inlet 1, thereby allowing the faucet system to operate in two modes: a manual mode, in which the flow of water is controlled by the valves 113, 114 provided in the faucet assembly 110, and an instrumented mode in which water flow magnitude and temperature are controllably adjusted by the valves 3, 4 provided in the kit 200 and part of the faucet system 100.

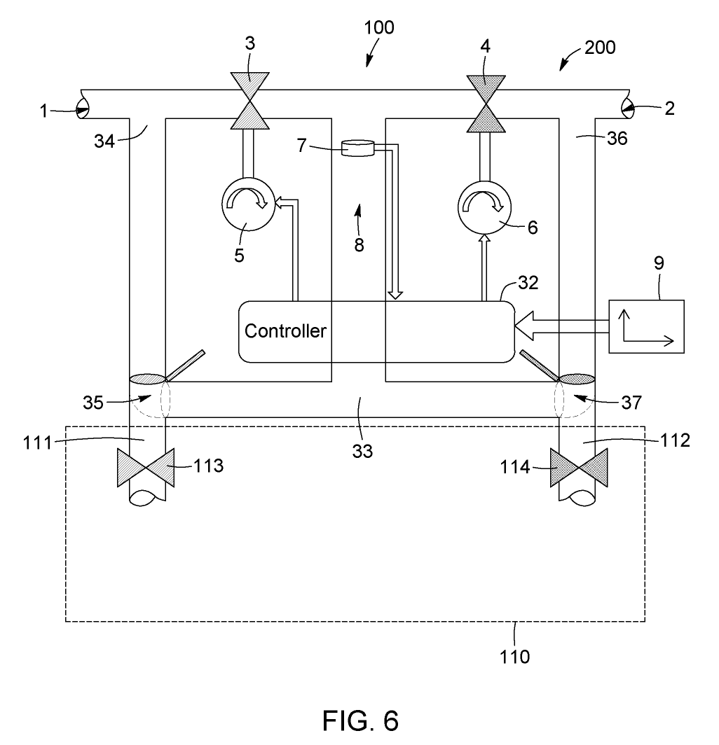

It should be appreciated that other bypass mechanisms and arrangements are also possible. For example, the hot water inlet 2 could be provided with a bypass T-section rather than the cold water inlet 1. In alternate embodiments, more T-sections can be provided, for example to provide individual dedicated bypass paths for each of the inputs of the faucet assembly. For example, as illustrated in FIG. 6, a second T-section 36 can be provided as a bypass for the hot water inlet 1. The bypass paths can, for example, be activated by switchable gates 35, 37.

Referring back to FIG. 5, in manual mode, the hot water valve 4 of the faucet system is set to its fully opened position and the cold water valve 3 of the faucet system is set to its fully closed position. This allows the faucet assembly 110 to control hot and cold water flow in its conventional fashion, using its own valves.

In instrumented mode, the faucet assembly 110 has its hot water valve 114 set to its fully open position, while the faucet assemblies' 110 cold water valve 113 is set to its fully closed position. With this setting, the water flow and temperature is fully controlled by the hot and cold valves 4, 3 of the faucet system 100.

The following Table summarizes the settings for both modes:

TABLE 2
Valve settings in manual mode and instrumented mode

| | Faucet System | | Faucet Assembly | |
|---|---|---|---|---|
| Mode | Hot Valve | Cold Valve | Hot Valve | Cold Valve |
| Manual | On | Off | Variable | Variable |
| Instrumented | Variable | Variable | On | Off |

As can be appreciated, this arrangement allows a simple way to switch between manual and instrumented modes without the need for additional valves or pipe deviations.

3. Method for Adjusting Water Flow Through a Faucet Assembly

According to an aspect, the above described system and kit implement a method for adjusting water flow through a faucet system. Broadly described, the method involves the main steps of generating a gesture signal responsive to a user gesture along one or two substantially continuous axes of a sensor pad; and with respect to each of said one or two substantially continuous axes: processing the gesture signal to determine therefrom a selected flow temperature or a selected flow magnitude from a substantially continuous range of possible values; and automatically adjusting at least one of a hot component and a cold component of a flow of water through the faucet system such that a combination of said hot and cold components corresponds to the selected flow temperature or the selected flow magnitude.

It will be readily understood that such a method may be applied to a faucet system 100 such as the one shown in FIG. 1. In other variants, the method can also describe the operation of a faucet system 100 formed by retrofitting a faucet assembly 110 using a kit 200 such as described above with reference to FIGS. 5 and 6. It will be further understood that in other variants the method described herein may alternatively be carried out using faucet systems and/or assemblies having different configurations without departing from the scope of the present invention. Furthermore, while the method described below is suitable for use with a sensor pad embodied by a touchpad, resistive or otherwise and preferably foot operated, in other variants different types of sensor pads and different positioning of the sensor pad can be considered.

In the embodiment illustrated in FIG. 1, the one or two substantially continuous axes are first and second orthogonal axes 91, 92. In this variant the input module 33 receives (x,y) coordinates generated by the touchpad 9, with the coordinates corresponding to positions of the user gesture along the first and second orthogonal axes 91, 92 respectively. As can be appreciated, the coordinates comprise a component along the first axis 91, i.e. the x component, and a component along the second axis 92, i.e. the y component. In an embodiment, the selected flow temperature is determined according to the component along the first axis, for example the x axis, while the selected flow magnitude is determined according to the component along the second axis, for example the y axis. This can be accomplished, for example, by determining a relative distance traveled by the user gesture along the corresponding substantially continuous axes, and mapping the relative distance traveled to a relative change in the selected flow temperature or the selected flow magnitude.

In an embodiment, mapping the coordinates can be accomplished by first identifying a starting coordinate corresponding to a start position of the user gesture along one of the substantially continuous axes. Next, an ending coordinate can be identified, the ending coordinate corresponding to an end position of the user gesture along the corresponding substantially continuous axis. With the start and end positions identified, the difference between these points can be calculated in order to determine a distance traveled, and this distance can be mapped to a selected flow temperature or the selected flow magnitude. As can be appreciated, the selected flow temperature or flow magnitude can correspond to an absolute temperature or flow magnitude value, or to a relative change to a current flow temperature or flow magnitude.

In an embodiment, processing the gesture signal can include identifying whether the user gesture corresponds to one of a stroke gesture and a tap gesture. As one skilled in the art understands, this can be accomplished, for example, by determining whether the user gesture traveled a significant distance, or whether the user gesture was focused on a limited portion of the sensor pad. It can also be accomplished by identifying “Pen Up” or “Pen Dow” signals, if these signals are available from the sensor pad.

As can be appreciated, the meaning of the stroke gesture and tap gestures can vary according to different implementations. In some implementations, upon identifying the tap gesture, the selected flow temperature or the selected flow magnitude is adjusted instantaneously according to a commanded open-to-close or close-to open state transition. In other words, the tap can cause the faucet system 100 to toggle between an on and an off state. For example, upon identifying the tap gesture while the faucet system 100 is in the open state, the faucet system 100 can be automatically operated into the closed state, and upon identifying the tap gesture while the faucet system 100 is in the closed state, the faucet system can be automatically operated to enter the open state.

In some implementations, a current value of the flow temperature or flow magnitude can be saved in memory 60 before operating the faucet system 100 into the closed state responsive to a tap command. In this fashion, the saved flow temperature and flow magnitude can be restored when the faucet system 100 is operated back into the open state, for example responsive to a subsequent tap command. In an embodiment, the stored values can be associated with a number “n” corresponding to a number of taps registered. This can involve identifying a number of sequential taps “n” and, upon identifying n sequential taps while the faucet system 100 is in the open position, a current flow temperature and flow magnitude are associated with the n sequential taps in memory 60 and, upon identifying n sequential taps while the faucet system 100 is in the closed position, the flow temperature and flow magnitude associated with the n sequential taps are restored.

The stroke gesture can cause a change in flow temperature and/or flow magnitude of water flowing through the faucet system 100. In embodiments where the faucet system 100 is operable between an open state in which water flows through the faucet system 100, and a closed state in which water flow through the faucet system 100 is interrupted, the selected flow temperature or the selected flow magnitude can be continuously adjusted according to a stroke gesture, regardless of the state. For example, if the faucet system 100 is in the closed state, the stroke gesture can cause the faucet assembly 100 to enter the open state and adjust the flow temperature and magnitude as usual.

If the input pattern corresponds to a tap or a stroke, a selected flow magnitude and/or flow temperature can be determined by converting the coordinates from the gesture signal 11 into flow magnitude and temperature set points 12.

Once the selected flow temperature and magnitude have been identified, the hot and cold water valves 3, 4 can be automatically operated, thereby adjusting the hot and/or cold component to attain the flow magnitude and temperature at the outlet 8. In an embodiment, this can involve automatically adjusting at least one of the hot component and the cold component, such that a ratio of the hot component to the cold component is modified. This can also involve automatically adjusting the at least one of the hot component and the cold component such that a combined flow magnitude of the hot component and the cold component is modified.

In embodiments such as the one described in FIG. 1, the hot and cold water valves can be operated by actuators. In such configurations, automatically adjusting the at least one of the hot component and the cold component can include generating actuator control signals to automatically operate the actuators. This can involve the actuator control module 18 taking the flow magnitude and temperature set points 12 and converting them into cold valve and hot valve opening set points for sending commands through the actuator control signals 14 and 15 to the hot and cold valve actuators. The magnitude and temperature of water flowing from the faucet system 100 are thus controlled responsive to user gestures from the touchpad 9 in this fashion.

In order to more accurately control the flow of water, the actuators can be operated in two stages: first through an open-loop or predictive stage to coarsely adjust the flow, and second through a closed-loop or reactive stage to finely adjust the flow using feedback signals. In such an operation, the opening set-points of the hot and cold valves can be said to comprise open-loop coarse opening set-points and closed-loop fine opening set-points. Adjusting at least one of the hot component and the cold component includes first determining the coarse opening set-points using predictive algorithms, and then respectively operating the hot and cold water valves to their determined coarse opening set-points. Next, an output feedback signal can be received, the signal corresponding to a measured temperature of the water flow through faucet system 100. An error can be determining between the selected flow temperature and the output feedback signal; and that error can be reduced by respectively modifying the hot and cold water valves to the fine opening set-points, while maintaining the output flow constant.

In an embodiment, the predictive algorithm for determining the coarse opening set-points can use temperature readings from the hot and cold inlets in order to create a more accurate prediction. Such an algorithm can include the steps of: receiving two input signals corresponding to measured temperatures of the hot and cold components, respectively; determining a ratio of the hot component to the cold component required to obtain the selected flow temperature, according to the hot and cold component input signals; determining a scaling factor of the hot component and the cold component required to obtain the selected flow magnitude; and calculating the coarse opening set-points of the hot and cold valves respectively, scaled to obtain the selected flow magnitude while respecting the previously determined hot and cold components ratio.

In some embodiments, the input signals can correspond to instantaneous temperature values at the hot and cold water inlets. However, in alternate embodiments, it may be desirable to predict the coarse opening set points using historical temperature values. In this fashion, the prediction algorithm will not be thrown off by fluctuations at the inlets. In such embodiments, the input signals can correspond to average temperatures of the hot and cold input components, respectively, as estimated from measurements over the course of a predetermined period of time. Such measurements can, for example, be taken at predetermined intervals, saved into memory 60, for example in the input memory module 61.

As can be appreciated, the above described methods can apply equally to faucet systems where the faucet assembly has the actuators and corresponding valves integrated therein, and to faucet systems where an existing faucet system is retrofitted with the actuators and corresponding valves. In an embodiment such as the latter, the adjusted cold water flow can be provided directly to a cold water inlet of the faucet assembly, and the adjusted hot water flow can be provided to a hot water inlet of the faucet assembly. Alternatively, as shown in FIG. 5, the hot and cold components can be mixed before providing them to an input of the existing faucet assembly. In some embodiments, the mixed components can be provided to only one of the hot water input or the cold water input of the faucet assembly, with that input of the faucet assembly being set to a near maximum magnitude, while the other input is set to a near zero magnitude. In this fashion, only the mixed water will flow through the faucet assembly, allowing it to be completely controlled by the system.

In some embodiments, the system can be operated such that the automatic mixing features of the present system are bypassed, and the faucet assembly can function as a normal unautomated faucet. Responsive to receiving a command to enter a non-instrumented mode, the flow of water through the faucet system can be automatically adjusted so that the flow of water through the faucet system includes the hot component at a near maximum magnitude and the cold component at a near zero magnitude. In this fashion, the faucet assembly will be provided with hot and cold components as normal, as though it were connected directly to both the hot and cold water inlets.

In the embodiment of FIG. 1, the user is also provided with visual feedback of the set points. The temperature display 16 can be driven by the actuator control module 18, and can be configured to show the temperature set point. In some implementations, the displayed temperature set point flashes until the temperature is attained at which point the displayed temperature is fixed. In addition to the temperature display 16, the user can perceive the flow magnitude by observing the actual water flow magnitude from the faucet system.

In the embodiment of FIG. 1, an auxiliary button 31 is also provided. This button 31 can, for example, be used to impose upper and/or lower limits on the flow magnitude and/or flow temperature. When used as such, the method of adjusting water flow through the faucet system can include limiting the selected flow temperature and the selected flow magnitude to a predetermined range. The predetermined range can, for example, be pre-set and hardcoded into the controller 32. Alternatively, the range can be set manually by the user, for example, by providing the controller 32 with a proper command, through the sensor pad 9 and/or through the button 31.

In more detail now, the following sections describe exemplary techniques for processing input signals and generating control signals. The techniques describe signal processing techniques to control the flow of water through the faucet system, such that the magnitude and temperature of the water can be controlled independently, responsive to an input from a sensor pad along first and second orthogonal axes. Additionally, the magnitude and temperature of the water can be controlled substantially continuously, being incrementally altered responsive to a user input along a substantially continuous axes of a sensor pad. The following techniques are but some of several possible ways to process signals and should not be taken to limit the scope of the invention.

### 3.1 Details of Input Module

### 3.1.1 Tap Pattern Determination

Generally speaking, a tap can be defined as a momentary stroke lasting a small period of time, typically less than 200 milliseconds. The input module can compute the time delay between the start of a stroke (determined by a Pen_Up/Pen_Down transition) and the end of a stroke (determined by a Pen_Down/Pen_Up transition).

If the time delay is less than the established tap threshold delay, then the stroke is considered as being a tap. Otherwise, the stroke is considered as being a command and will be converted into flow magnitude and temperature set points.

The input software module monitors and identifies consecutive taps and executes system designer-defined tasks such as the ones defined in Table 1, above, representing the preferred embodiment of the invention.

Opening the faucet by tap actions restores the corresponding set point and results into the faucet automatically returning to the said set point.

3.1.2 Conversion into (Magnitude, Temperature) Set Point

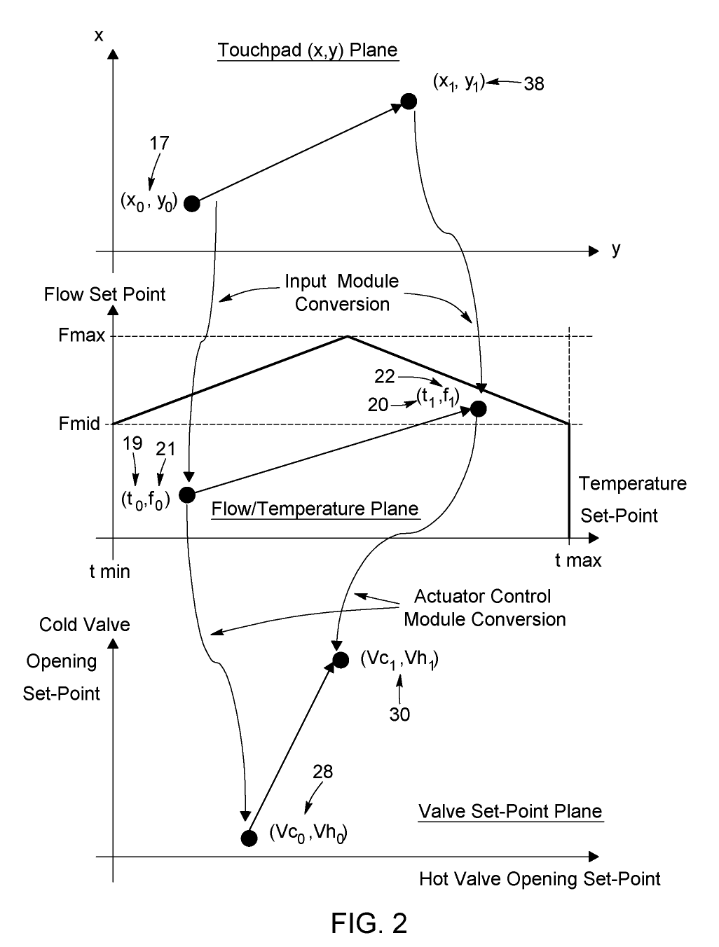

With reference to FIG. 2, the input module computes the following:

Delta_x=x1−x0 [1]

Delta_y=y1−y0 [2]

### Where:

(x0,y0) is the initial touchpad point 17
(x1,y1) is the following touchpad point 38

In a preferred embodiment, Delta_x is associated to a temperature change and Delta_y is associated to a magnitude change.

### Set Point Computation, Nominal Case

The new set-point for temperature is defined as:

t1=t0+a*Delta_x [3]

### Where:

t0: previous temperature set point 19
t1: new temperature set point 20
a: scaling factor between displacement along x axis and temperature

The new set point for magnitude is defined as:

f1=f0+b*Delta_y [4]

### Where:

f0: previous magnitude set point 21
f1: new magnitude set point 22
b: scaling factor between displacement along y axis and magnitude

From the above, it is seen that the touchpad movement initiates a change in set point relative to the previously existing set points, therefore implementing a relative set-point change. This allows the stroke to be randomly located on the touchpad e.g. the user does not need to generate the stroke at any specific (x,y) coordinates on the touchpad area.

### Set-Point Computation, General Case

The nominal case set point computation is valid as long as the requested set point (tr,fr) remains within the boundaries of minimum and maximum temperature attainable as well as maximum flow magnitude available. These are ultimately bound by the minimum and maximum inlet water temperatures available and by the minimum and maximum valve opening points.

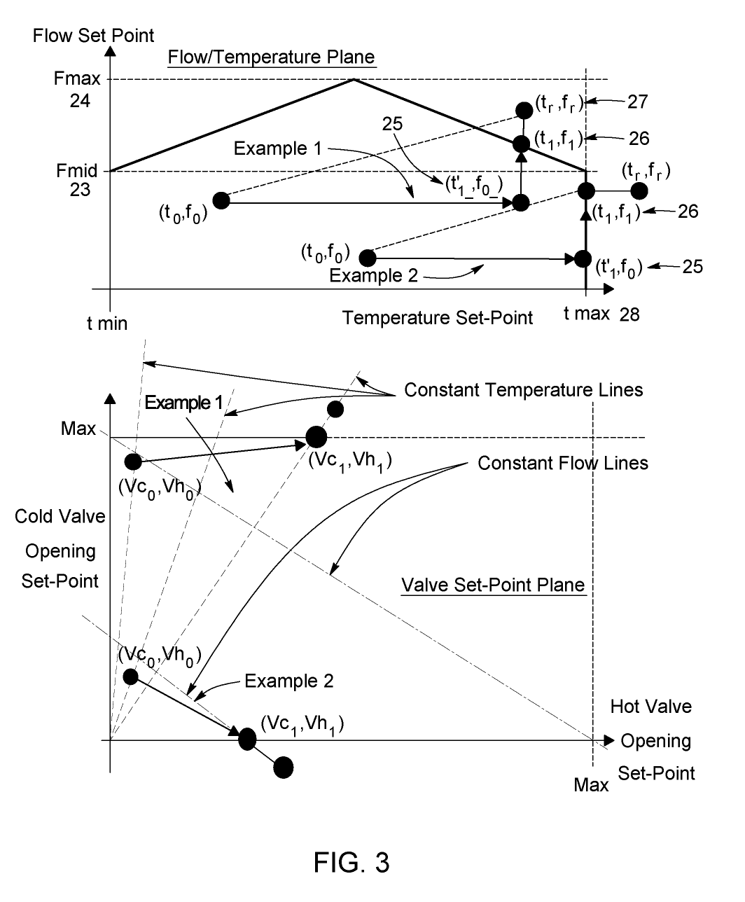

With reference to FIG. 3, we will assume that if only the cold valve was open to its maximum, the generated flow magnitude would be equal to fmid 23. Similarly, if only the hot valve was open to its maximum, the generated flow magnitude would be equal to fmid 23. If both the hot and cold valves were open to their maximum, the resulting flow magnitude would be fmax=2*fmid 24. This assumption is valid as long as both hot and cold valves have the same characteristics, the pressure in each inlet is the same, and the cross section of the outlet piping is equal to or larger than the cross section of the hot and cold valves combined, which is the usual case. If this assumption doesn't hold, we would have to take into account the specific characteristics of the valves and the associated piping. The shape of the temperature/magnitude set point plane would be somewhat affected. However, the control principles described herein would remain the same.

FIG. 3 shows two examples of a more general case where the desired new set point couple (tr,fr) 27 might fall outside the available temperature/magnitude domain. In a preferred embodiment of the invention, the temperature set-point is favored with respect to the magnitude set point. In other words, if it is not possible to provide the desired temperature/magnitude couple, the new set point will, when possible, favor the establishment of the desired temperature over the desired magnitude. In FIG. 3 example 1, an intermediate set point (t1′, f0) 25 is established to provide the desired temperature while the magnitude is unchanged. Then a final set point (t1, f1) 26 is established where the temperature is maintained constant while the magnitude is changed up to the maximum available value.

Example 2 shows the same process where the maximum available temperature tmax 28 is lower than the desired new temperature set point tr so t1′ is set to tmax. Then the magnitude is increased to the desired value f2 in order to yield the set point (t1,f1) 26.

FIG. 3 also shows the corresponding set point movements in the cold valve opening versus hot valve opening plane.

From the above discussion, a set point couple (t1,f1) is computed by the input software module as a composite movement of temperature set point at constant magnitude followed by a magnitude set point at constant temperature, taking into account the limits of the temperature vs magnitude domain. The resulting set point couple is then passed to the actuator control software module.

### 3.2 Details of Actuator Control Module Conversion

### 3.2.1 General

In the present embodiment, the actuator control module has four inputs: the set point couple described above, the cold and hot water inlet temperatures and the actual water temperature T0 read from the faucet outlet temperature sensor. As shown in FIG. 2, this software module uses this data to compute new cold and hot valve opening set points.

The preferred embodiment of the actuator control software is a two-step process. Step A is an open loop step whereby the hot and cold valve opening set points are computed from predictive equations. This step yields a coarse temperature setting. Step B is a closed-loop step allowing fine tuning of the outlet water temperature.

### 3.2.2 Step A

This step implies that the controller has some knowledge of the cold and hot water inlet temperatures. Typically these temperatures will vary as follows:
Short term variations occur when the faucet has not been used for a while. When not in use, the faucet piping temperature along with the still water within the pipes tend towards room temperature. When the faucet is operated, water circulation will change the temperature of the piping and water located directly at the inlets will eventually reach steady values.
Long term variations are due to phenomena such as seasonal variations of supply water temperature. For instance, during winter the supply water temperature is normally colder than during summertime.

In order to cope with the two variations identified above, the controller has to regularly update inlet water temperatures by filtering inlet water temperature readings in order to obtain good approximations of actual inlet water temperatures. While there are several ways to implement this filter, the essential idea is to retain the coldest cold water inlet temperature recorded over a certain period of use (typically a few days or the last few uses) which will be called tmin in the following discussion. Likewise, the hottest hot water inlet temperature recorded over a similar period of use is recorded as tmax.

The preferred embodiment of the invention makes use of electronic temperature sensors. Several such sensors are available in the form of integrated circuits. The response time of these sensors is not very critical because the sampling period can be relatively long, in the order of several tens of seconds when the faucet is in use.

The latest values available of tmin and tmax actually define the water temperature bounds shown in FIGS. 2 and 3.

With the knowledge of these temperatures, and still with the reasonable assumption that the cold and hot water inlet pressure are the same, the hot and cold valve opening set point is predicted using the following equations:

Vc1=Kf1(tmax−t1)/(tmax−tmin) [5]

Vh1=Kf1(t1−tmin)/tmax−tmin) [6]

These two equations can be derived by applying simple algebra to FIG. 3, noting that in this graph, locus of constant temperature are defined by lines having the same cold-to-hot valve opening ratio (essentially defining the slope of the line) and locus of constant flow are defined by lines where the sum of cold valve opening and hot valve opening are constant. As can be appreciated, such a calculation involves determining a relative ratio of hot and cold water flow required to obtain a desired temperature, and combined flow of the hot and cold water flow required to obtain a desired overall flow magnitude.

### 3.2.3 Step B

Step A of the Actuator Control Software Module generates predictive values Vc1 and Vh1 per above computation. Experimental data shows that in most cases, the actual outlet temperature obtained by this method is pretty close from the desired temperature, typically to within a couple of degrees Celsius. Higher deviations from the desired temperature are due to phenomenon such as:
differences in hot and cold water inlet pressure (for example due to water demand from another faucet or device such as a dishwashing machine)
differences in the calibration of cold and hot water valve zero flow setting which biases the outlet hot-to-cold water ratio at low water flow set points. This phenomenon becomes negligible at higher water flow.

Step B of the actuator control module comes into play when the water flow resulting from Vc1 and Vh1 settings has been established. Its purpose is to establish closed-loop regulation of the water outlet temperature while maintaining a constant flow. This will be done by increasing one actuator setting and lowering the other actuator setting by the same amount so that the sum of the two settings is constant, yielding a constant water flow.

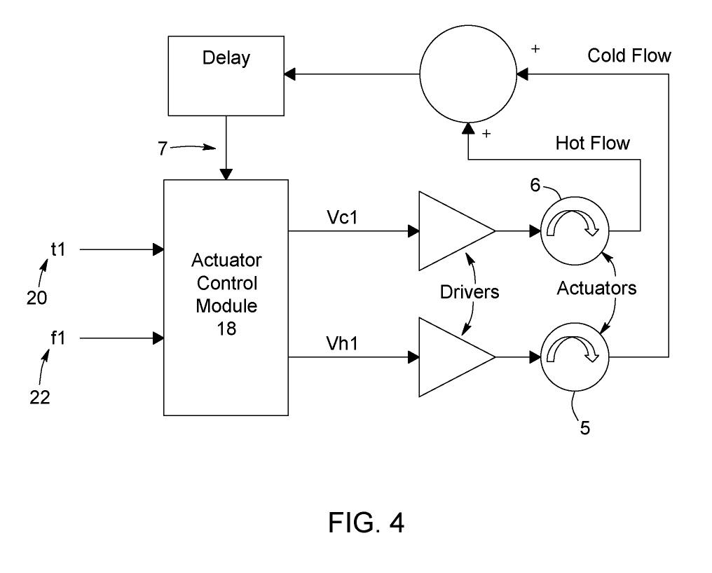

FIG. 4, shows the closed-loop control system formed by the actuator control module, the actuators, and the water outlet temperature reading fed back to the Actuator Control Software Module. In this system, the change of water flow magnitude virtually responds instantaneously to a change of actuator position. However, the temperature at the outlet of the faucet will change after a certain delay due to the thermal inertia of the faucet piping. More importantly, all temperature measurement devices have a certain reaction time or time constant which induces further delay, or lag, in obtaining a water outlet temperature reading. The system of FIG. 4 can therefore be modelled as a position servo system with a delay in the feedback signal. The optimisation of such a system is well described by commonly known control system theory.

In some embodiments, control law terms can be added within the actuator control module in order to optimize the system's response. These are dependent upon the specific physical characteristics of the system.

To obtain good control loop performances, the selection of temperature sensor along with its location and mounting on the faucet outlet is important. Low thermal inertia, quick-reacting devices mounted directly in the water flow, such as a thermocouple work best.

### 3.2.3 Description of the Boost Function

When the temperature set point is very different from the actually measured faucet outlet temperature, it is desirable to speed-up the process of attaining the desired temperature normally slowed down by the thermal inertia of the system.

This can be accomplished by a boost function implemented within the actuator control module. When this function is invoked, the hot and cold water valves are momentarily commanded to their maximum or minimum values (fully on or fully off) according to entries of Table 3.

TABLE 3
Boost Function Operation

| Initial Condition | Boost Function Action |
|---|---|
| Temperature set at high | Hot water valve momentarily fully on |
| value while actual faucet | Cold water valve momentarily fully off |
| temperature is low | |
| Temperature set at low | Hot water valve momentarily fully off |
| value while actual faucet | Cold water valve momentarily fully on |
| temperature is high | |

Invoking the boost function is accomplished by verifying if the absolute value of (T0-t1) (e.g. the faucet outlet temperature minus the temperature set-point) is greater than the system designer-defined upper threshold. If yes, then the boost function overrides the normal actuator set point process. Control is reverted back to the normal process when the absolute value of (T0-t1) is lower than the system designer-defined lower threshold.

### 4. Auxiliary Function

As described above, the system can include a concealed discrete push button (or other type of user interface) which is used to set and actually limit the maximum water magnitude and temperature that the controller will allow. This function is useful to save water by limiting the maximum water magnitude below the maximum magnitude normally provided by the un-instrumented faucet. It is also useful to prevent injuries and save energy by limiting the maximum temperature delivered below the maximum magnitude normally provided by the un-instrumented faucet. To operate this function, the faucet is brought to the wanted magnitude and temperature limits using touchpad commands. The pushbutton is then pressed which in turn causes the controller to memorize the magnitude and temperature limits. This information can, for example, be stored in memory in the controller. From that point-on, the set points transferred to the actuator control software will be limited to these values by the input software module. Pressing this button while the faucet is off resets the maximum allowed magnitude and temperature to their default value which are equal to the maximum values of the un-instrumented faucet.

1. A method for adjusting water flow through a faucet system, the method comprising the steps of:
generating a gesture signal responsive to a user gesture along one or two substantially continuous axes of a sensor pad; and
with respect to each of said one or two substantially continuous axes:
processing the gesture signal to determine therefrom a selected flow temperature or a selected flow magnitude from a substantially continuous range of possible values by determining a relative distance traveled by the user gesture along the corresponding substantially continuous axis, and mapping the relative distance traveled to a relative change in the selected flow temperature or the selected flow magnitude; and
automatically adjusting at least one of a hot component and a cold component of a flow of water through the faucet system such that a combined flow of said hot and cold components corresponds to the selected flow temperature or the selected flow magnitude.

2. The method according to claim 1, wherein the gesture signal comprises coordinates corresponding to positions of the user gesture along the one or two substantially continuous axes, and wherein processing the gesture signal comprises:
identifying a starting coordinate corresponding to a start position of the user gesture along the corresponding substantially continuous axis;
identifying an ending coordinate corresponding to an end position of the user gesture along the corresponding substantially continuous axis;
calculating a difference between the starting and ending coordinates; and
mapping the difference to a change in the selected flow temperature or the selected flow magnitude.

3. The method according to claim 1, wherein automatically adjusting the at least one of the hot component and the cold component comprises modifying a ratio of the hot component to the cold component.

4. The method according to claim 1, wherein automatically adjusting the at least one of the hot component and the cold component comprises modifying a combined flow magnitude of the hot component and the cold component.

5. The method according to claim 1, wherein the one or two substantially continuous axes comprise first and second orthogonal axes, and wherein processing the gesture signal comprises determining the selected flow temperature according to a component of the user gesture along the first axis, and determining the selected flow magnitude according to a component of the user gesture along the second axis.

6. The method according to claim 1, wherein adjusting the at least one of the hot component and the cold component comprises operating at least one of a hot water valve and a cold water valve, the hot and cold water valves respectively controlling water flow from a hot water source and a cold water source.

7. The method according to claim 6, wherein the hot and cold water valves are operated by actuators, and wherein automatically adjusting the at least one of the hot component and the cold component comprises generating actuator control signals to automatically operate the actuators.

8. The method according to claim 6, wherein automatically adjusting the at least one of the hot component and the cold component comprises determining opening set-points for each of the hot and cold water valves, and operating the hot and cold water valves to their respective determined opening set-points.

9. The method according to claim 8, wherein the opening set-points comprise open-loop coarse opening set-points and closed-loop fine opening set-points, and wherein automatically adjusting the at least one of the hot component and the cold component comprises:
determining the coarse opening set-points;
respectively operating the hot and cold water valves to their determined coarse opening set-points;
receiving an output feedback signal corresponding to a measured temperature of the combined flow of the hot and cold components;
determining an error between the selected flow temperature and the output feedback signal; and
reducing the error by respectively modifying the hot and cold water valves to the fine opening set-points while maintaining the output flow constant.

10. The method according to claim 9, wherein determining the coarse opening set-points comprises the steps of
receiving temperature input signals corresponding to measured temperatures of the hot and cold components, respectively;
determining a ratio of the hot component to the cold component required to obtain the selected flow temperature, according to the hot and cold component temperature input signals;
determining a scaling factor of the hot component and the cold component required to obtain the selected flow magnitude; and
calculating the coarse opening set-points of the hot and cold valves respectively, scaled to obtain the selected flow magnitude while respecting the determined ratio of the hot component to the cold component.

11. The method according to claim 10, wherein the temperature input signals are measured over the course of a predetermined period of time by at least one of an output temperature sensor while the faucet system delivers only cold or hot water, or by cold and hot input temperature sensors in order to estimate temperatures of the hot and cold input components, respectively.

12. The method according to claim 1, further comprising the step of mixing the hot and cold components before providing them to an input of a faucet assembly.

13. The method according to claim 12, wherein the faucet assembly comprises a hot water input and a cold water input, and wherein the method comprises the step of providing the mixed hot and cold components to one of the hot water input and the cold water input of the faucet assembly.

14. The method according to claim 13, further comprising the step of providing one of the hot and cold components directly to the other one of the hot water input and the cold water input of the faucet assembly.

15. The method according to claim 14, further comprising operating the faucet system in an instrumented mode wherein the one of the hot water input and the cold water input of the faucet assembly is set to a near maximum magnitude, and the other one of the hot water input and the cold water input of the faucet assembly is set to a near zero magnitude.

16. The method according to claim 14, further comprising receiving a command to enter a non-instrumented mode and, responsive to said command, automatically providing the hot component entirely to the hot water input of the faucet assembly and providing the cold component entirely to the cold water input of the faucet assembly.

17. (canceled)

18. The method according to claim 1, wherein processing the gesture signal comprises identifying whether the user gesture corresponds to a stroke gesture, further wherein upon identifying the stroke gesture, the faucet system is operable to continuously adjust the selected flow temperature or the selected flow magnitude according to the stroke gesture.

19. (canceled)

20. The method according to claim 1, wherein processing the gesture signal comprises identifying whether the user gesture corresponds to a tap gesture, further wherein the faucet system is operable between an open state in which water flows through the faucet system, and a closed state in which water flow through the faucet system is interrupted, and upon identifying the tap gesture, the selected flow temperature or the selected flow magnitude is adjusted instantaneously according to a commanded open-to-close or close-to open state transition.

21. (canceled)

22. The method according to claim 20, further comprising the steps of storing a current flow temperature and flow magnitude in memory before operating the faucet system into the closed state, and restoring the stored flow temperature and flow magnitude from memory when operating the faucet system into the open state.

23. The method according to claim 22, wherein identifying the tap gesture comprises identifying a number of “n” sequential taps and, upon identifying the “n” sequential taps while the faucet system is in the open position, a current flow temperature and flow magnitude are associated with the “n” sequential taps in memory and, upon identifying the “n” sequential taps while the faucet system is in the closed position, the flow temperature and flow magnitude associated with the “n” sequential taps are restored.

24. (canceled)

25. The method according to claim 1, wherein the sensor pad comprises a foot-operated sensor pad.

26. (canceled)

27. (canceled)

28. A kit for retrofitting a faucet assembly and forming a faucet system comprising:
a hot water valve connectable to a hot water source and operable to control a flow of hot water into the faucet assembly;
a cold water valve connectable to a cold water source and operable to control a flow of cold water into the faucet assembly;
a sensor pad having one or two substantially continuous sensing axes, the sensor pad generating a gesture signal responsive to a user gesture along the one or two substantially continuous sensing axes; and
a controller in communication with the sensor pad and operatively connectable to the hot and cold water valves, the controller being operable to process the gesture signal along each of the one or two substantially continuous sensing axis to:
determine a selected flow temperature or a selected flow magnitude from a substantially continuous range of possible values by determining a relative distance traveled by the user gesture along the corresponding substantially continuous axis, and mapping the relative distance traveled to a relative change in the selected flow temperature or the selected flow magnitude; and
operate the hot and cold water valves to automatically control the flow of hot water and cold water such that a combined flow of the hot and cold water through the faucet assembly corresponds to the selected flow temperature or the selected flow magnitude.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A faucet system for providing an adjustable water flow, the system comprising:
a hot water inlet;
a cold water inlet;
a mixed water outlet;
hot and cold water valves operable to respectively control a flow of hot water through the hot water inlet and a flow of cold water through the cold water inlet, the flow of hot and cold water combining into a flow of mixed water through the mixed water outlet;
a sensor pad having one or two substantially continuous sensing axes, the sensor pad generating a gesture signal responsive to a user gesture along the one or two substantially continuous sensing axes; and
a controller in communication with the sensor pad and operatively connected to the hot and cold water valves, the controller being operable to process the gesture signal along each of the one or two substantially continuous sensing axes to:
determine a selected flow temperature or a selected flow magnitude from a substantially continuous range of possible values by determining a relative distance traveled by the user gesture along the corresponding substantially continuous axis, and mapping the relative distance traveled to a relative change in the selected flow temperature or the selected flow magnitude; and
operate the hot and cold water valves to automatically control the flow of hot water and cold water such that the flow of the mixed water corresponds to the selected flow temperature or the selected flow magnitude.

41. (canceled)

42. (canceled)

43. (canceled)

44. (canceled)

45. (canceled)

46. (canceled)

47. (canceled)

48. (canceled)

49. (canceled)

50. (canceled)

51. (canceled)
